(19) United States
(12) Patent Application Publication
(10) Pub. No.: US 2016/0283916 A1
(43) Pub. Date: Sep. 29, 2016

(54) EQUIPMENT MANAGING SYSTEM AND EQUIPMENT MANAGING METHOD

(71) Applicant: KYOCERA CORPORATION, Kyoto-shi, Kyoto (JP)

(72) Inventors: Kei IWATA, Kawasaki-shi, Kanegawa (JP); Mitsuhiro KITAJI, Yokohama-shi, Kanegawa (JP); Ryuta FUJISAWA, Kawasaki-shi, Kanegawa (JP); Ryutaro MAYUMI, Yokohama-shi, Kanegawa (JP)

(21) Appl. No.: 15/033,575

(22) PCT Filed: Oct. 29, 2014
(86) PCT No.: PCT/JP2014/078797

§ 371 Date: Apr. 29, 2016

(30) Foreign Application Priority Data
Oct. 29, 2013 (JP) 2013-224568
Oct. 29, 2013 (JP) 2013-224775

(51) Int. Cl. G06Q 10/00

(52) U.S. Cl. CPC G06Q 10/20

(57) ABSTRACT

Equipments managing apparatus 200 comprises a storage unit 200 configured to store equipment information including maintenance information for each of the plurality of equipments; and a calculation unit 230 configured to calculate a first index value indicating a maintenance priority among the plurality of equipments for each of the plurality of equipments based on predetermined information commonly included in each of the pieces of equipment information.

### TECHNICAL FIELD

The present invention relates to an equipment managing system and an equipment managing method.

### BACKGROUND ART

Conventionally, multiple equipments are used in facilities such as stores, plants, or office buildings (hereinafter, referred to as the facilities). In such facilities, maintenance of equipments is carried out to maintain functions and performance of the equipments. The maintenance includes repair for solving a problem in an existing equipment, for example, based on a predetermined plan and replacement for replacing an existing equipment with a new equipment based on predetermined durable years,

Therefore, an equipments managing system has been proposed which stores and manages information corresponding to equipments used in a facility, that is, basic information including types, used periods, and durable years of equipments and maintenance information including maintenance implementation histories of the equipments in a database (for example, see Patent Literature 1).

### CITATION LIST

### Patent Literature

Patent Literature 1: Japanese Application Publication No. 2005-182399

### SUMMARY OF INVENTION

However, various types of equipments are used in a facility. In the above-mentioned database, information items and the number of pieces of information vary depending on the types of the equipments. Accordingly, it is difficult to compare pieces of information corresponding to multiple equipments having different types and to grasp states of the multiple equipments.

Therefore, an object of the present invention is to provide an equipments managing system, an equipments managing apparatus, and an equipments managing method that can easily manage multiple equipments having different types and manage equipments installed in multiple facilities.

An equipments managing system according to a first aspect manages information corresponding to a plurality of equipments which are different in type. The equipments managing system comprises a storage unit configured to store equipment information including maintenance information for each of the plurality of equipments; and a calculation unit configured to calculate a first index value indicating a maintenance priority among the plurality of equipments for each of the plurality of equipments based on predetermined information commonly included in each of the pieces of equipment information.

An equipments managing method according to a second aspect is an equipments managing method of an equipments managing apparatus that manages information corresponding to a plurality of equipments which are different in type. The equipments managing method comprises a step of storing equipment information including maintenance information for each of the plurality of equipments: and a step of calculating a first index value indicating a maintenance priority among the plurality of equipments for each of the plurality of equipments based on predetermined information commonly included in each of the pieces of equipment information.

An equipments managing system according to a third aspect manages information corresponding to a first equipment installed in a first facility and information corresponding to a second equipment installed in a second facility different from the first facility. The equipments managing system comprises a storage unit configured to store usage environment information for the first equipment and usage environment information for the second equipment; an extraction unit configured to extract common information, which is commonly included in the usage environment information corresponding to the first equipment and the second equipment, from the usage environment information; and a calculation unit configured to calculate a second index value which is obtained by normalizing one piece of numerical data corresponding to the first equipment using the common information corresponding to the first equipment and a third index value which is obtained by normalizing one piece of numerical data corresponding to the second equipment using the common information corresponding to the second equipment.

An equipments managing method according to a fourth aspect is an equipments managing method of managing information corresponding to a first equipment installed in a first facility and information corresponding to a second equipment installed in a second facility other than the first facility. The equipments managing method comprises a step of storing usage environment information for the first equipment and usage environment information for the second equipment; a step of extracting common information, which is commonly included in the usage environment information corresponding to the first equipment and the second equipment, from the usage environment information; and a step of calculating a second index value which is obtained by normalizing one piece of numerical data corresponding to the first equipment using the common information corresponding to the first equipment and a third index value which is obtained by normalizing one piece of numerical data corresponding to the second equipment using the common information corresponding to the second equipment.

### BRIEF DESCRIPTION OF DRAWINGS

FIG. 1 is a diagram illustrating an equipments managing system according to a first embodiment and a second embodiment.

FIG. 2 is a block diagram of a user terminal according to the first embodiment.

FIG. 3 is a block diagram illustrating an equipments managing apparatus according to the first embodiment.

FIG. 4 is a diagram illustrating an example of a display mode according to the first embodiment.

FIG. 5 is a diagram illustrating an example of a display mode according to the first embodiment.

FIG. 6 is a flowchart illustrating an equipments managing method according to the first embodiment.

FIG. 7 is a block diagram of a user terminal according to the second embodiment.

FIG. 8 is a block diagram illustrating an equipments managing apparatus according to the second embodiment.

FIG. 9 is a diagram illustrating an example of a display mode according to the second embodiment.

FIG. 10 is a diagram illustrating an example of a display mode according to the second embodiment.

FIG. 11 is a flowchart illustrating an equipments managing method according to the second embodiment.

### DESCRIPTION OF EMBODIMENTS

Hereinafter, a control system according to embodiments of the present invention will be described with reference to the accompanying drawings. In the following description with reference to the drawings, like or similar elements will be referenced by like or similar reference numerals.

Here, it should be noted that the drawings are schematic and dimensional ratios thereof are different from real ones. Accordingly, specific dimensions and the like should be determined in conjunction with the following description. The dimensional relationships or ratios of the elements may vary depending on the drawings.

### Summary of First Embodiment

An equipments managing system according to a first embodiment manages information corresponding to a plurality of equipments which are different in type. The equipments managing system comprises a storage unit configured to store equipment information including maintenance information for each of the plurality of equipments; and a calculation unit configured to calculate a first index value indicating a maintenance priority among the plurality of equipments for each of the plurality of equipments based on predetermined information commonly included in each of the pieces of equipment information.

In the first embodiment, an index value (first index value) indicating maintenance priority in multiple equipments is calculated based on predetermined information which is commonly included in the equipment information for the multiple equipments. Accordingly, it is possible to provide an equipments managing system, an equipments managing apparatus, and an equipments managing method that can calculate the index value (first index value) indicating the maintenance priority as a common criterion for each of the multiple equipments which are different in type.

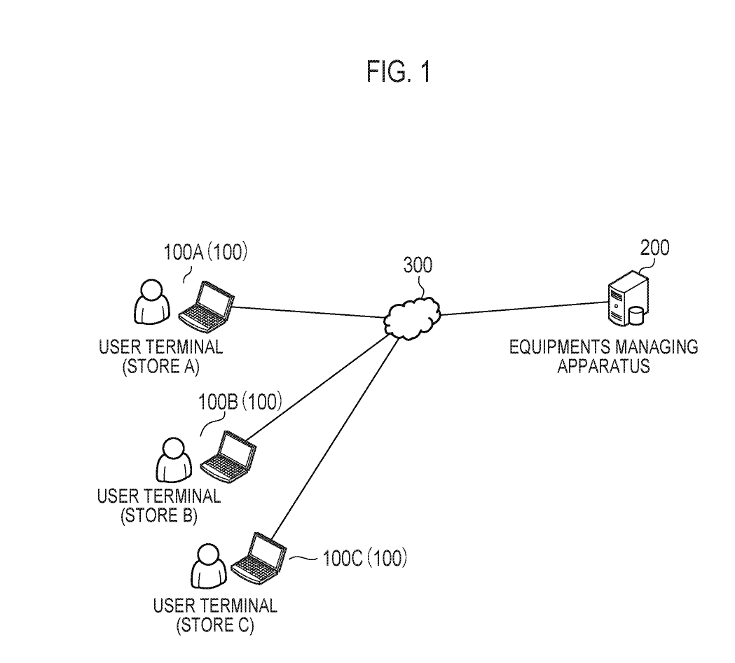

An equipments managing system according to the first embodiment will be described below. FIG. 1 is a diagram illustrating an equipments managing system according to the first embodiment and a second embodiment to be described later.

As illustrated in FIG. 1, the equipments managing system according to the first embodiment includes a user terminal 100 and an equipments managing apparatus 200. The user terminal 100 and the equipments managing apparatus 200 are connected to each other via a network 300.

The user terminal 100 is installed in a facility in which multiple equipments different in type are used. Examples of the multiple equipments include air conditioners, illuminations, and cooling cases.

The user terminal 100 is an apparatus that is used to input and display information on equipments used in the facility. In FIG. 1, store A and store B which are chain stores of the same group are illustrated as the facility.

In FIG. 1, the user terminal 100 includes a user terminal 100A which is installed in store A, a user terminal 100B which is installed in stored B, and a user terminal 1000 which is installed in headquarters controlling store A and store B. The user terminal 100A mainly inputs and displays information on equipments installed in store A. The user terminal 100B mainly inputs and displays information on equipments installed in store B. The user terminal 1000 mainly displays information on the equipments installed in store A and store B.

The user terminal 100A may be connected to the equipments installed in store A, for example, via a wired LAN or a wireless LAN disposed in store A. The user terminal 100B may be connected to the equipments installed in store B. for example, via a wired LAN or a wireless LAN disposed in store B.

The equipments managing apparatus 200 is, for example, a network server. The equipments managing apparatus 200 manages information of equipments which are installed in facility (store A and store B).

The network 300 is an example of a public communication line and examples thereof include the Internet, a wide-area line network, a narrow-area line network, and a mobile phone network.

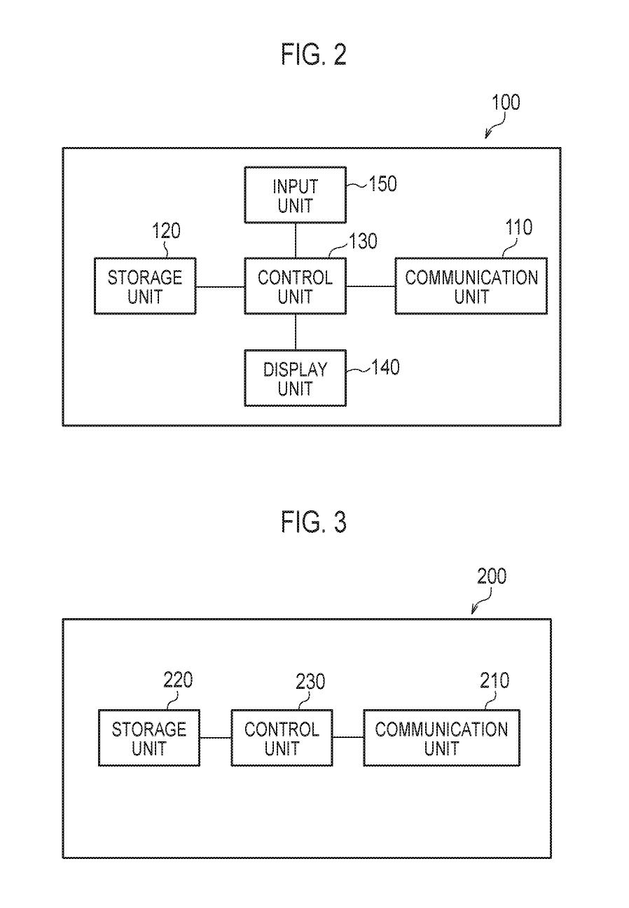

FIG. 2 is a block diagram of the user terminal according to the first embodiment.

As illustrated in FIG. 2, the user terminal 100 (the user terminal 100A, the user terminal 100B, and the user terminal 100C) according to the first embodiment includes a communication unit 110, a storage unit 120, a control unit 130, a display unit 140, and an input unit 150.

The communication unit 110 communicates with the equipments managing apparatus 200 via the network 300. The communication unit 110 transmits information input via the input unit 150 to be described later to the equipments managing apparatus 200. The communication unit 110 receives display data to be described later from the equipments managing apparatus 200.

The storage unit 120 stores the information received by he communication unit 110.

The control unit 130 controls the operation of the user terminal 100.

The display unit 140 displays display data received by the communication unit 110 or display data stored in the storage unit 120 using a web browser or the like.

In the first embodiment, the display unit 140 displays information for specifying multiple equipments and the index values (first index values) corresponding to the multiple equipments using a graph. The index values (first index values) corresponding to the multiple equipments will be described later. Alternatively, the display unit 140 displays information for specifying types of equipments and numerical values obtained by collecting index values (first index values) corresponding to the multiple equipments for each type of equipments, for example, using a radar chart.

The input unit 150 is a keyboard or the like for allowing a user to input information on facilities and equipments. The user inputs information for specifying display data to be displayed on the display unit 140 via the input unit 150. The input unit 150 may be incorporated into the display unit 140, for example, like a touch panel.

FIG. 3 is a block diagram of the equipments managing apparatus according to the first embodiment.

As illustrated in FIG. 3, the equipments managing apparatus 200 according to the first embodiment includes a communication unit 210, a storage unit 220, and a control unit 230.

The communication unit 210 communicates with the user terminal 100 (the user terminal 100A, the user terminal 100B, and the user terminal 100C) via the network 300. The communication unit 210 transmits display data which is generated by the control unit 230 to be described later to the user terminal 100. The communication unit 210 receives information transmitted from the user terminal 100.

The storage unit 220 stores information received by the communication unit 210. Specifically, the storage unit 220 stores equipment information including basic information and maintenance information for each of the multiple equipments. Here, the basic information includes at least predetermined durable years of an equipment or a deadline based on the predetermined durable years and a used period, and the maintenance information includes at least a number of times of maintenance implementation for each equipment. The basic information may further include rated power of each equipment. The maintenance information may further include a maintenance implementation plan. The storage unit 220 may further store basic information (such as a business hours and a floor area) of a facility.

The control unit 230 controls the operation of the equipments managing apparatus 200.

In the first embodiment, the control unit 230 calculates an index value (first index value) indicating a maintenance priority among multiple equipments for each equipment based on predetermined information which is commonly included in the pieces of equipment information. That is, the control unit 230 corresponds to a calculation unit in the equipments managing system. The control unit 230 generates display data including the index values (first index values) indicating the maintenance priorities of the equipments.

Here, the predetermined information includes, for example, predetermined durable years of each equipment, a used period of the equipment, and a number of times of maintenance implementation of the equipment. The maintenance includes, for example, fixing of solving a problem of an equipment at the time of failure of the equipment and repair of solving a problem of an equipment based on a predetermined plan. The maintenance further includes replacement of replacing the equipment itself with a new one.

An equipment is basically degrading as the used period (years after the equipment is introduced) gets closer to the durable years. When maintenance is appropriately carried out, degradation of an equipment is suppressed and thus necessity for urgent maintenance is kept low. On the contrary, when the number of times of maintenance is small, degradation of an equipment is accelerated and thus necessity for urgent maintenance increases. On the basis of this idea, the control unit 230 calculates the index values (first index values) indicating maintenance priorities of the equipments, for example, using the following calculation.

For example, in case of an equipment which has ten durable years and which is repaired once per year, 20 points are added to the index value (first index value) every year and 10 points are subtracted therefrom when repair is carried out. When fixing is carried out, three points are added thereto.

An expected date of replacement of the equipment may be considered in calculating the index value (first index value). For example, when an equipment having 10 durable years is expected to be replaced in 8 years after the equipment is introduced in a middle/long-term plan, an increasing rate of a degradation level may be adjusted to add 2.5 points (=100/8−10) to the index value (first index value) every year. On the contrary, when an equipment is expected to be replaced in 12 years after the equipment is introduced, 2.7 points (=100/12−10) may be subtracted from the index value (first index value).

When the equipment information includes an operation rate of the equipment, the operation rate of the equipment may be used as the predetermined information to calculate the index value (first index value). For example, since it is thought that an equipment having an operation rate of 30% has a failure rate lower than that of an equipment having an operation rate of 100%, 0.7 points (1−0.3) is subtracted from the index value (first index value) every year.

When the equipment information includes an energy saving rate, the energy saving rate may be as the predetermined information to calculate the index value (first index value). For example, when an air conditioner of a new model is present which has power consumption of 50% at the same horsepower as an air conditioner of an old model, the air conditioner of an old model is preferably replaced at an early stage from the viewpoint of running costs and thus two points are added to the index value (first index value) of the air conditioner of the old model every year.

In the first embodiment, the control unit 230 weights each of the predetermined information depending on an influence level of each of the predetermined information on the index value (first index value), and calculates the index value (first index value) corresponding to each of the multiple equipments using the weighted information. For example, in the above-mentioned calculation, 20 points are added to the index value (first index value) every year and 10 points are subtracted therefrom when repair is carried out. However, when the influence level of the aging degradation on the index value (first index value) is higher than the influence level of the number of times of repair implementation on the index value (first index value), for example, 25 points may be added to the index value (first index value) every year and five points may be subtracted therefrom when repair is carried out.

### (Display Mode)

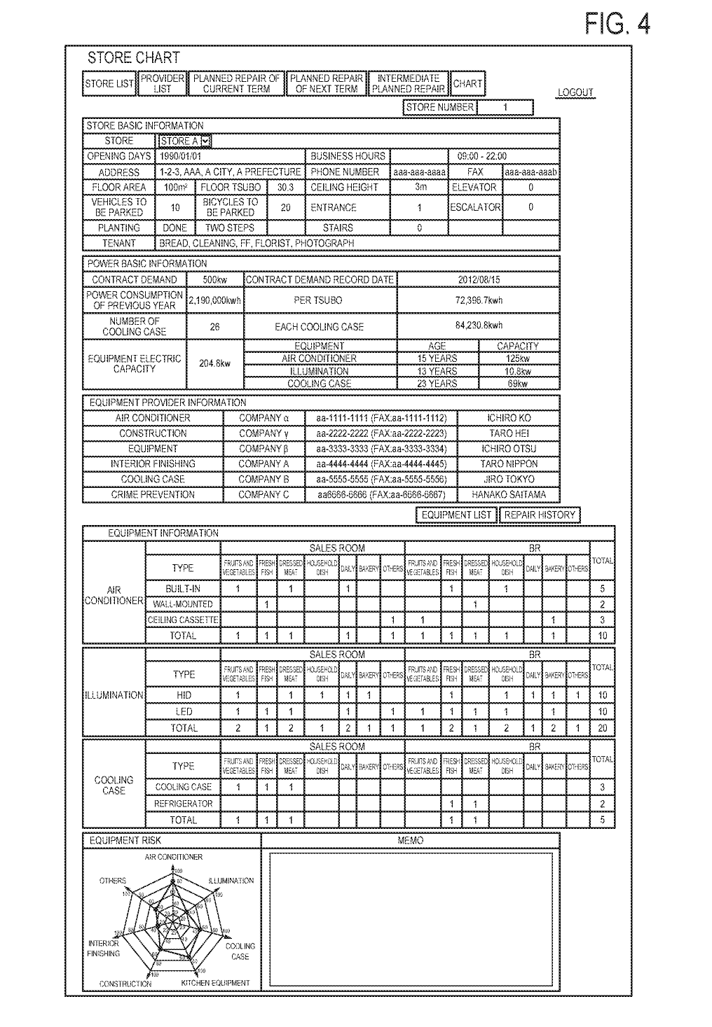

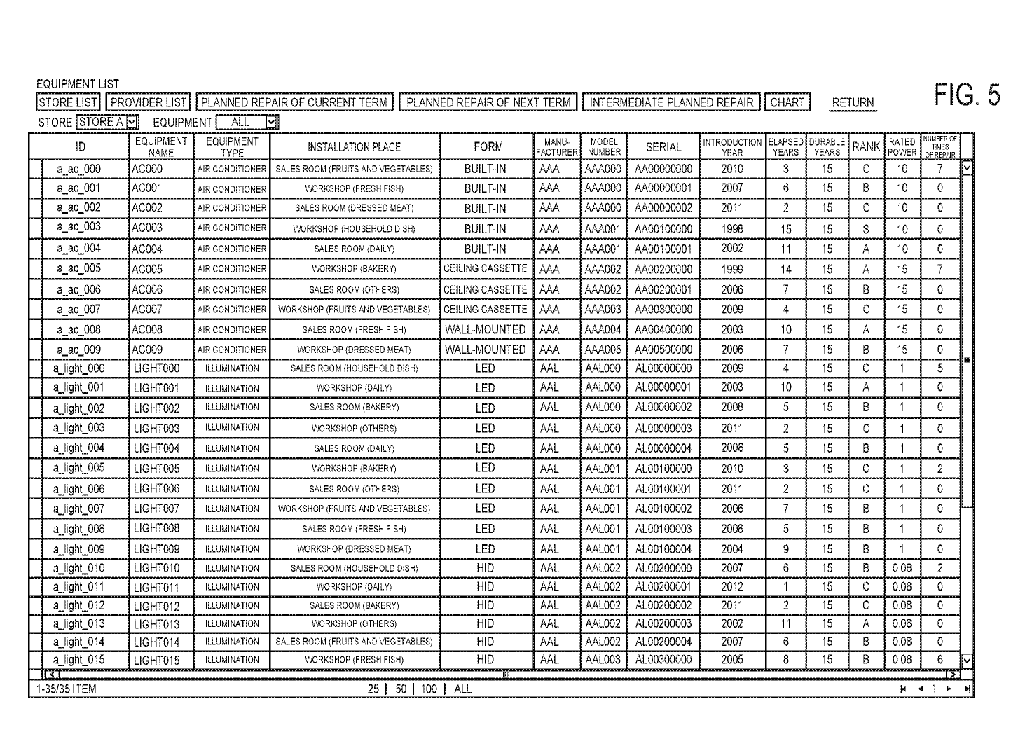

A display mode according to the first embodiment will be described below. FIGS. 4 and 5 are diagrams illustrating an example of the display mode according to the first embodiment.

As illustrated in FIG. 4, the display unit 140 displays information on a selected store as a store chart. In FIG. 4, the display unit 140 displays store basic information of the selected store (store A herein), power basic information, equipment provider information, equipment information, and equipment risk in the form of a table. The store basic information includes opening days, business hours, an address, a phone number, a floor area, and the like of the store. The power basic information includes contract demand for power, power consumption of the previous year, and equipment electric capacity. The equipment provider information includes a company name, a phone number, and a name of a person in charge of an equipment provider taking charge of maintenance of the equipment.

The equipment information illustrated in FIG. 4 is information obtained by extracting and integrating partial information from the equipment information of each equipment which is described with reference to FIG. 5 and includes, for example, types and installation positions of equipments installed in the store and the number of equipments.

The equipment risk is information indicating degradation level of equipments in the selected store for each type of equipments. In FIG. 4, the degradation level for each type of equipments in the selected store (store A herein) is displayed in a radar chart. For example, the degradation level for each type of equipments is an average value of the index values (first index values) which are calculated using the above-mentioned calculation for each type of equipments.

As illustrated in FIG. 5, the display unit 140 displays equipment information including basic information and maintenance information of each equipment. The display unit 140 displays a list of equipments installed in the selected store and detailed information of each equipment in the form of a table. Here, it should be noted that the items of the equipment information and the number of pieces of equipment information vary depending on the types of the equipments.

For example, in FIG. 5, store A is selected and IDs, names, equipment types (types), installation positions, shapes, manufacturers, model numbers, serial numbers, introduction years, durable years, ranks, rated power, and repair frequencies of equipments installed in store A are displayed.

The ranks are obtained by classifying the equipments into four ranks of rank S, rank A, rank B, and rank C based on the index values (first index values) indicating maintenance priorities of the equipments. In case of equipments having a maintenance priority becoming lower (a degradation level becoming lower) as the index value (first index value) becoming less, for example, an equipment classified into rank S is an equipment having an index value (first index value) less than 20, an equipment classified into rank A is an equipment having an index value (first index value) equal to or greater than 20 and less than 50, an equipment classified into rank B is an equipment having an index value (first index value) equal to or greater than 50 and less than 80, and an equipment classified into rank C is an equipment having an index value (first index value) equal to or greater than 80.

### (Equipments Managing Method)

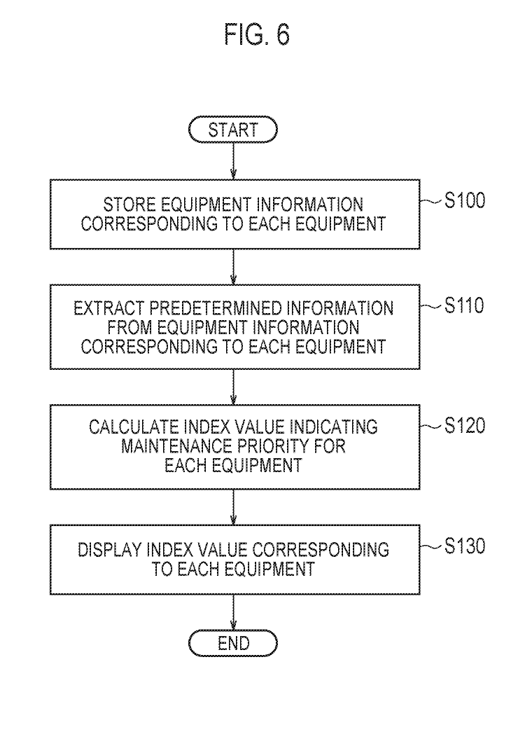

An equipments managing method according to the first embodiment will be described below. FIG. 6 is a flowchart illustrating the equipments managing method according to the first embodiment.

As illustrated in FIG. 6, in step S100, the equipments managing apparatus 200 stores equipment information corresponding to the equipments.

In step S110, the equipments managing apparatus 200 extracts predetermined information from the equipment information corresponding to the equipments. The predetermined information includes, for example, predetermined durable years of the equipments, used periods of the equipments, and maintenance implementation frequencies of the equipments.

In step S120, the equipments managing apparatus 200 calculates an index value (first index value) indicating a maintenance priority of each equipment based on the predetermined information corresponding to the equipments.

In step S130, the equipments managing apparatus 200 displays the index values (first index values) corresponding to the equipments.

As described above, the equipments managing system according to the first embodiment calculates the index value (first index value) indicating the maintenance priority among multiple equipments based on the predetermined information which is commonly included in the equipment information for each of the equipments. That is, even when the items of information to be managed and the number of pieces of information vary depending on the equipments different in type, the equipments managing system according to the first embodiment extracts information, which is commonly included and required for calculating the index value (first index value) and calculates the index value (first index value) indicating the maintenance priority as a common criterion. Accordingly, a user can relatively compare the maintenance priorities of the multiple equipments different in type and can appropriately manage the equipments.

### Other Embodiments

While the embodiment of the present invention has been described above, the description and drawings constituting a part of the disclosure should not be understood to limit the present invention. Various alternative embodiments, examples, and operation techniques will be apparent to those skilled in the art from the disclosure.

In the first embodiment, the equipments managing apparatus 200 is described to be a network server. However, the equipments managing apparatus 200 may be disposed in the facility in which the equipments are used. In this case, the equipments managing apparatus 200 may be connected to the user terminal 100 and the equipments installed in the facility via a wired LAN or a wireless LAN disposed in the facility. In this case, the display unit displaying the index values (first index values) indicating the maintenance priorities of the equipments may be disposed in the equipments managing apparatus 200 instead of the user terminal 100.

In the first embodiment, an example in which the maintenance priorities of multiple equipments installed in one facility are calculated has been described. However, the present invention can also be applied to a case in which maintenance priorities of multiple equipments which are installed in multiple facilities are calculated and compared with each other.

### Summary of Second Embodiment

An equipments managing system according to a second embodiment manages information corresponding to a first equipment installed in a first facility and information corresponding to a second equipment installed in a second facility different from the first facility. The equipments managing system comprises a storage unit configured to store usage environment information for the first equipment and usage environment information for the second equipment; an extraction unit configured to extract common information, which is commonly included in the usage environment information corresponding to the first equipment and the second equipment, from the usage environment information; and a calculation unit configured to calculate a second index value which is obtained by normalizing one piece of numerical data corresponding to the first equipment using the common information corresponding to the first equipment and a third index value which is obtained by normalizing one piece of numerical data corresponding to the second equipment using the common information corresponding to the second equipment.

In the second embodiment, the index values (second index value and third index value) obtained by normalizing one of numerical data corresponding to the equipments are calculated using the common information which is commonly included in the usage environment information corresponding to the equipments. Accordingly, it is possible to provide an equipments managing system, an equipments managing apparatus, and an equipments managing method that can facilitate comparison of equipments installed in multiple facilities and construct an environment capable of realizing easy management.

### Second Embodiment

The equipments managing system according to the second embodiment will be described below. The equipments managing system according to the second embodiment is the same equipments managing system as illustrated in FIG. 1.

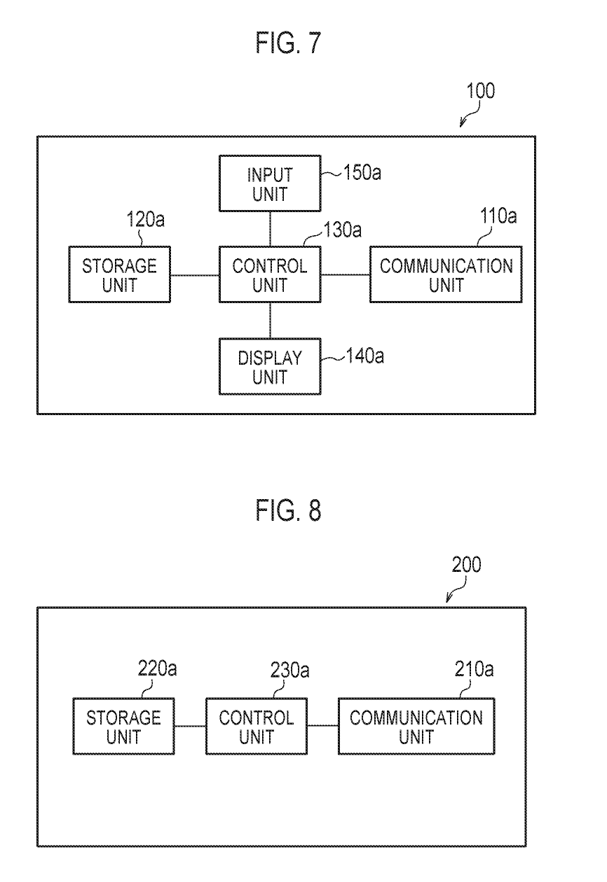

FIG. 7 is a block diagram of a user terminal according to the second embodiment.

As illustrated in FIG. 7, a user terminal 100 (a user terminal 100A, a user terminal 100B, and a user terminal 100C) according to the second embodiment includes a communication unit 110a, a storage unit 120a, a control unit 130a, a display unit 140a, and an input unit 150a.

The communication unit 110a communicates with the equipments managing apparatus 200 via the network 300. The communication unit 110a transmits information input via the input unit 150a to be described later to the equipments managing apparatus 200. The communication unit 110a receives display data to be described later from the equipments managing apparatus 200.

The storage unit 120a stores the information received by the communication unit 110a.

The control unit 130a controls the operation of the user terminal 100.

The display unit 140a displays display data received by the communication unit 110a or display data stored in the storage unit 120a using a web browser or the like.

In the second embodiment, the display unit 140a displays an index value (second index value) corresponding to equipment A in correlation with information for specifying store A and displays an index value (third index value) corresponding to equipment B in correlation with information for specifying store B. The index value (second index value) corresponding to equipment A and the index value (third index value) corresponding to equipment B will be described later.

The display unit 140a displays the information for specifying store A and the information for specifying store B in the order based on the size of the index value (second index value) correlated with store A and the index value (third index value) correlated with store B. Alternatively, the display unit 140a highlights the facility correlated with the index value greater than a threshold value among the index value (second index value) correlated with store A and the index value (third index value) correlated with store B or highlights the facility correlated with the index value less than the threshold value among the index value (second index value) correlated with store A and the index value (third index value) correlated with store B.

The input unit 150a is a keyboard or the like for allowing a user to input information on facilities and equipments. Here, information on the stores and the equipments may be input via only the input unit 150a of the user terminal 100C installed in the headquarters, or only information on its own store and equipments thereof may be input via the user terminal (the user terminal 100A or the user terminal 100B) installed in its own store.

A user inputs information for specifying display data to be displayed on the display unit 140a via the input unit 150a. Here, in the user terminal 1000 installed in the headquarters, information for displaying information on a store and equipments on the display unit 140a can be input via the input unit 150a. In the user terminal 100A and the user terminal 100B, inputting of information for displaying information on the other store may be partially limited. The input unit 150 may be incorporated into the display unit 140a, for example, like a touch panel.

FIG. 8 is a block diagram of the equipments managing apparatus according to the second embodiment.

As illustrated in FIG. 8, the equipments managing apparatus 200 according to the second embodiment includes a communication unit 210a, a storage unit 220a, and a control unit 230a.

The communication unit 210a communicates with the user terminal 100 (the user terminal 100A, the user terminal 100B, and the user terminal 100C) via the network 300. The communication unit 210a transmits display data which is generated by the control unit 230a to be described later to the user terminal 100. The communication unit 210a receives information transmitted from the user terminal 100.

The storage unit 220a stores information received by the communication unit 210a. Specifically, the storage unit 220a stores usage environment information for equipment A and usage environment information for equipment B. It should be noted that the usage environment information is information indicating an environment of a facility in which the equipment is installed and may include different information depending on facilities. The usage environment information includes, for example, business hours of the facility in which the equipment is installed or an area corresponding to a single equipment.

The storage unit 220a stores numerical data which is measured for each equipment. The numerical data is data for comparing real operation efficiency or failure rates of the equipments and an example of the numerical data is power consumption of each equipment. The storage unit 220a stores numerical data of each of equipment A and equipment B in correlation with the usage environment information of the corresponding equipment.

The storage unit 220a may store equipment information including basic information and maintenance information for each of equipment A and equipment B. Here, the basic information includes at least predetermined durable years of an equipment or a deadline based on the predetermined durable years and a used period, and the maintenance information includes at least a number of times of maintenance implementation for each equipment. The basic information may further include rated power of each equipment. The maintenance information may further include a maintenance implementation plan.

The control unit 230a controls the operation of the equipments managing apparatus 200.

In the second embodiment, the control unit 230a extracts common information, which is commonly included in the usage environment information of equipment A and equipment B, from the usage environment information. That is, the control unit 230a corresponds to an extraction unit of the equipments managing system.

The control unit 230a calculates the index value (second index value) obtained by normalizing one piece of the numerical data corresponding to equipment A using the common information corresponding to equipment A and the index value (third index value) obtained by normalizing one piece of the numerical data corresponding to equipment B using the common information corresponding to equipment B. That is, the control unit 230a corresponds to a calculation unit of the equipments managing system. The control unit 230a generates display data including the index values (second and third index values) corresponding to the equipments.

Here, the common information which is commonly included in the usage environment information corresponding to equipment A and equipment B is, for example, at least one of the business hours of the facility in which the equipment is installed and the area corresponding to each equipment.

For example, when the business hours of store A and store B are used as the common information, the control unit 230a calculates the index value (second index value) obtained by normalizing the power consumption of equipment A using the business hours of store A and the index value (third index value) obtained by normalizing the power consumption of equipment B using the business hours of store B. Specifically, the control unit 230a estimates a time length in which the power consumption of equipment A is measured based on the business hours of store A and calculates a value, which is obtained by dividing the power consumption of equipment A by the estimated time length, as the index value (second index value) corresponding to equipment A. Similarly, the control unit 230a estimates a time length in which the power consumption of equipment B is measured based on the business hours of store B and calculates a value, which is obtained by dividing the power consumption of equipment B by the estimated time length, as the index value (third index value) corresponding to equipment B.

Alternatively, when the area corresponding to each equipment A and the area corresponding to each equipment B are used as the common information, the control unit 230a calculates the index value (second index value) obtained by normalizing the power consumption of equipment A using the area corresponding to each equipment A and the index value (third index value) obtained by normalizing the power consumption of equipment B using the area corresponding to each equipment B. Specifically, the control unit 230a estimates the area corresponding to each equipment A based on the area of the installation place of equipment A and the number of equipments A installed and calculates a value, which is obtained by dividing the power consumption of equipment A by the estimated area, as the index value (second index value) corresponding to equipment A. Similarly, the control unit 230a estimates the area corresponding to each equipment B based on the area of the installation place of equipment B and the number of equipments B installed and calculates a value, which is obtained by dividing the power consumption of equipment B by the estimated area, as the index value (third index value) corresponding to equipment B.

### (Display Mode)

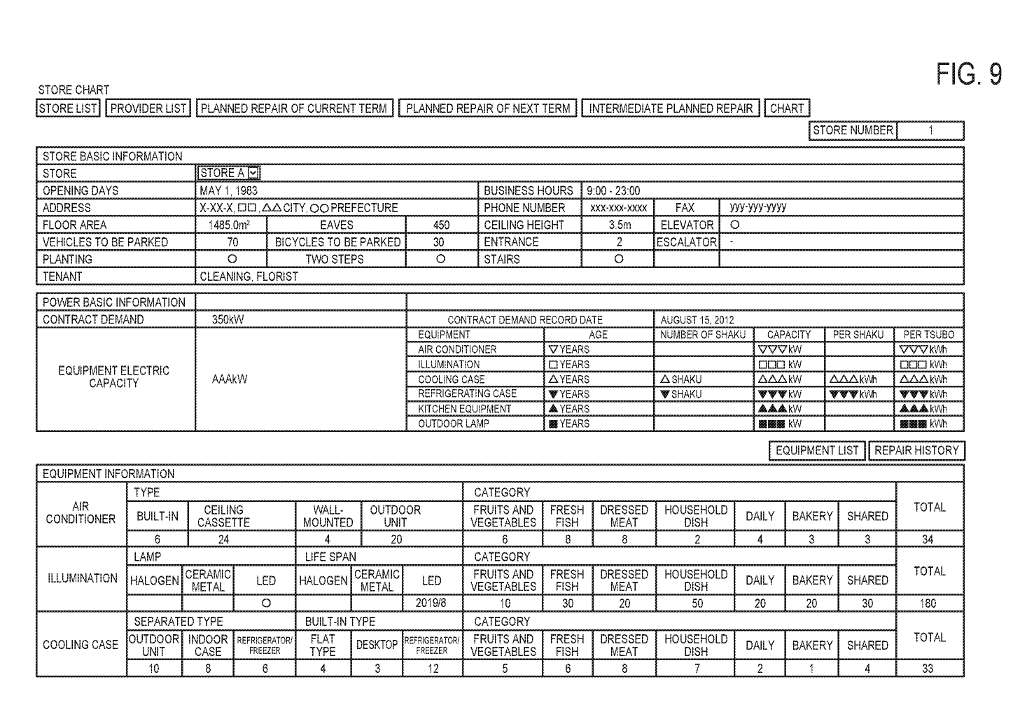

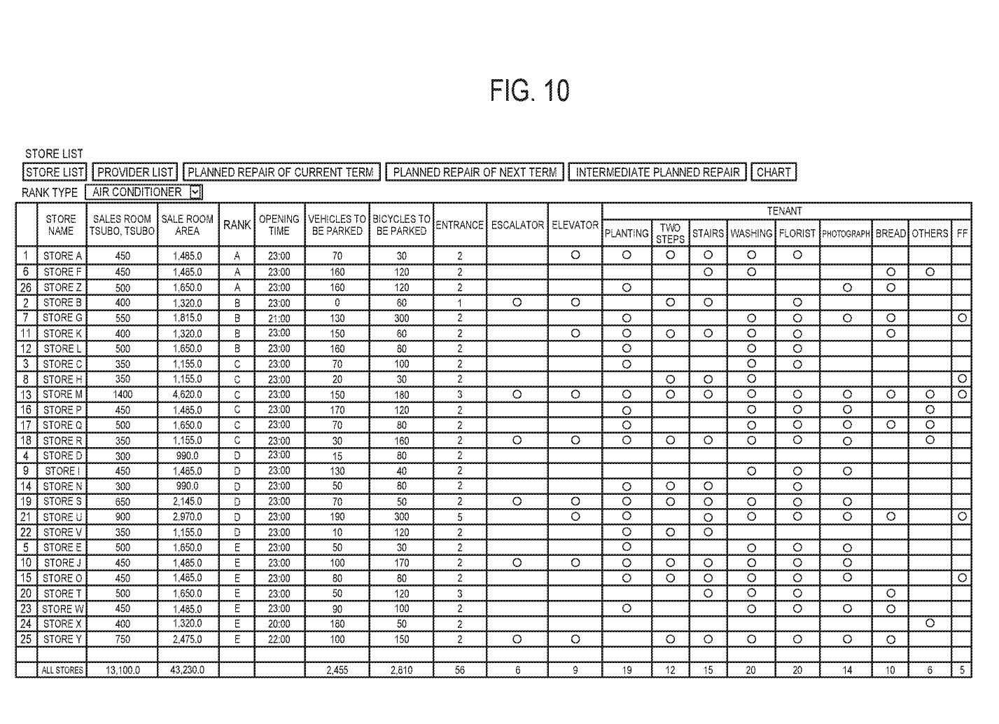

A display mode according to the second embodiment will be described below. FIGS. 9 and 10 are diagrams illustrating an example of the display mode according to the second embodiment. In FIGS. 9 and 10, multiple stores which are chain stores of the same group are exemplified as facilities. The control unit 230a calculates the index values (second and third index values) obtained by normalizing numerical data corresponding to the equipments installed in the multiple stores, as described above for store A and store B.

As illustrated in FIG. 9, the display unit 140a displays information on a selected store as a store chart. In FIG. 9, the display unit 140a displays store basic information of the selected store (store A herein), power basic information, and equipment information in the form of a table. The store basic information includes opening days, business hours, an address, a phone number, a floor area, and the like of the store. The power basic information includes contract demand for power, power consumption of the previous year, and equipment electric capacity. The equipment information includes types and installation positions of equipments (such as air conditioners, illuminations, and cooling cases) installed in the store and the number of equipments installed.

As illustrated in FIG. 10, the display unit 140a displays a list of stores in the form of a table. The display unit 140a displays the store basic information (a part of information illustrated in FIG. 9), an installation position of the selected equipment, and a rank to be described later in correlation with the name of the store. For example, the display unit 140a displays information on multiple stores depending on the rank of the selected equipment type. For example, in FIG. 10, an air conditioner is selected as the equipment type and the air conditioners installed in the stores are displayed by five steps of rank A to rank E. The information on the stores is displayed in a list depending on the ranks of the installed air conditioners.

Regarding the ranks of the equipment type, one of ranks A to E is assigned to all the index values (second and third index values) of the equipments installed in the stores based on the average value for each equipment type. In other words, the ranks of the equipment type can also be said to be store ranks for each equipment type. For example, when the ranks of the equipment type are assigned using the index values (second and third index values) obtained by normalizing the power consumption, an equipment having a smaller index value has higher operation efficiency. Accordingly, the ranks are classified into ranks A to E in the ascending order of numerical values of the averages of the index values. For example, when ranks are assigned to air conditioners, the air conditioners installed in store A are ranked based on the average values of the index values (second index values) corresponding to all the air conditioner installed in store A. Similarly, the air conditioners installed in another store are ranked.

### (Equipments Managing Method)

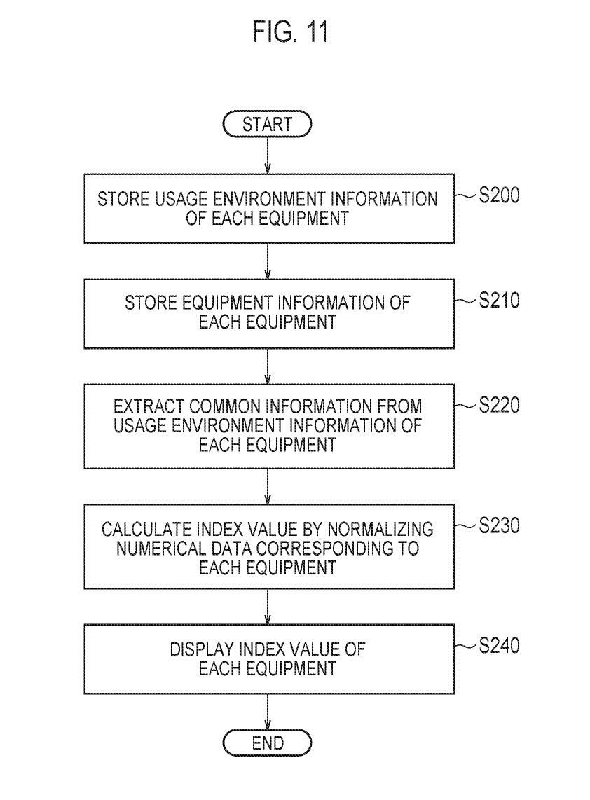

An equipments managing method according to the second embodiment will be described below. FIG. 11 is a flowchart illustrating the equipments managing method according to the second embodiment.

As illustrated in FIG. 11, in step S200, the equipments managing apparatus 200 stores usage environment information corresponding to the equipments.

In step S210, the equipments managing apparatus 200 stores equipment information corresponding to the equipments.

In step S220, the equipments managing apparatus 200 extracts common information, which is commonly included in the equipment information corresponding to the equipments, from the equipment information corresponding to the equipments. The common information includes, for example, at least one of the business hours of the facility in which the equipment is installed and the area corresponding to each equipment.

In step S230, the equipments managing apparatus 200 calculates the index values (second and third index values) by normalizing numerical data corresponding to the respective equipments based on the common information corresponding to the equipments.

In step S240, the equipments managing apparatus 200 displays the index values (second and third index values) corresponding to the respective equipments.

As described above, the equipments managing system according to the second embodiment extracts the common information which is commonly included in the usage environment information corresponding to the equipments installed in store A and store B and calculates the normalized index values (second and third index values) using the corresponding common information. That is, the equipments managing system according to the second embodiment calculates the index values (second and third index values) by normalizing the numerical data using the common information which is commonly included in the usage environment information in consideration that the numerical data corresponding to the equipments varies depending on the difference in usage environment. Accordingly, it is possible to appropriately compare the equipments by comparing the normalized index values (second and third index values) for the equipments. As a result, for example, in opening a new store, materials for determining appropriate rated power of equipments and the number of equipments can be acquired by referring to the index values (second and third index values) corresponding to the equipments installed in the existing stores.

Therefore, according to the present invention, it is possible to provide an equipments managing system, an equipments managing apparatus, and an equipments managing method that can facilitate comparing of equipments installed in multiple facilities and thus construct an environment of easy management.

### Other Embodiments

In the second embodiment, the equipments managing apparatus 200 is described to be a network server. However, the equipments managing apparatus 200 may be disposed in the facility in which the equipments are used. In this case, the equipments managing apparatus 200 may be connected to the user terminal 100 and the equipments installed in the facility via a wired LAN or a wireless LAN disposed in the facility. In this case, the display unit displaying the index values (second and third index values) corresponding to the equipments may be disposed in the equipments managing apparatus 200 instead of the user terminal 100.

In the second embodiment, equipment A and equipment B are described to be the same type of equipments having the same rated power However, the present invention can be applied even when the rated power of equipment A and the rated power of equipment B are different from each other. For example, when an index value greatly different from the other index values is present in the index values (second and third index values) corresponding to multiple equipments, it may be determined that the rated power of the equipment corresponding to the index value is not suitable for the usage environment and it may be considered that the rated power is changed to match the rated power of an equipment corresponding to another index value.

In the second embodiment, an example in which the power consumption is used as the numerical data corresponding to the equipments is described. However, the numerical data may be numerical data indicating a degradation level of an equipment, such as durable years, a used period, and a number of times of maintenance implementation of the equipment.

The entire contents of Japanese Patent Application No. 2013-224568 (filed Oct. 29, 2013) and Japanese Patent Application No. 2013-224775 (filed Oct. 29, 2013) are incorporated into this specification by reference.

### INDUSTRIAL APPLICABILITY

According to the present invention, it is possible to provide an equipments managing system and an equipments managing method that can easily manage multiple equipments having different types and manage equipments installed in multiple facilities.

1. An equipments managing system that manages information corresponding to a plurality of equipments which are different in type, comprising:
a storage unit configured to store equipment information including maintenance information for each of the plurality of equipments; and
a calculation unit configured to calculate a first index value indicating a maintenance priority among the plurality of equipments for each of the plurality of equipments based on predetermined information commonly included in each of the pieces of equipment information.

2. The equipments managing system according to claim 1, further comprising a display unit configured to display the first index value corresponding to each of the plurality of equipments.

3. The equipments managing system according to claim 2, wherein the display unit displays information for specifying each of the plurality of equipments and the first index value corresponding to each of the plurality of equipments in a graph.

4. The equipments managing system according to claim 1, wherein the storage unit further stores basic information of each of the plurality of equipments,
the basic information includes at least predetermined durable years or a deadline based on predetermined durable years and a used period, and
the maintenance information includes at least a number of times of maintenance implementation for the corresponding plurality of equipments.

5. The equipments managing system according to claim 1, wherein the calculation unit weights each of the predetermined information depending on an influence level of each of the predetermined information on the first index value and calculates the first index value corresponding to each of the plurality of equipments using the weighted information.

6. An equipments managing method of an equipments managing apparatus that manages information corresponding to a plurality of equipments which are different in type, comprising:
a step of storing equipment information including maintenance information for each of the plurality of equipments; and
a step of calculating a first index value indicating a maintenance priority among the plurality of equipments for each of the plurality of equipments based on information commonly included in each of the pieces of equipment information.

7. An equipments managing system that manages information corresponding to a first equipment installed in a first facility and information corresponding to a second equipment installed in a second facility different from the first facility, comprising:
a storage unit configured to store usage environment information for the first equipment and usage environment information for the second equipment;
an extraction unit configured to extract common information, which is commonly included in the usage environment information corresponding to the first equipment and the second equipment, from the usage environment information; and
a calculation unit configured to calculate a second index value which is obtained by normalizing one piece of numerical data corresponding to the first equipment using the common information corresponding to the first equipment and a third index value which is obtained by normalizing one piece of numerical data corresponding to the second equipment using the common information corresponding to the second equipment.

8. The equipments managing system according to claim 7, wherein the storage unit stores the numerical data of the first equipment and the second equipment in correlation with the usage environment information of the equipments.

9. The equipments managing system according to claim 7, wherein the numerical data is power consumption of the equipments.

10. The equipments managing system according to claim 7, further comprising a display unit configured to display the second index value corresponding to the first equipment in correlation with information for specifying the first facility and display the third index value corresponding to the second equipment in correlation with information for specifying the second facility.

11. The equipments managing system according to claim 10, wherein the display unit displays the information for specifying the first facility and the information for specifying the second facility in the order based on size of the second index value correlated with the first facility and the third index value correlated with the second facility.

12. The equipments managing system according to claim 10, wherein the display unit highlights the facility correlated with the index value greater than a threshold value among the second index value correlated with the first facility and the third index value correlated with the second facility or highlights the facility correlated with the index value less than the threshold value among the second index value correlated with the first facility and the third index value correlated with the second facility.

13. The equipments managing system according to claim 7, wherein the usage environment information includes at least one of business hours of the facility in which the equipment is installed and an area corresponding to the single equipment.

14. An equipments managing method of managing information corresponding to a first equipment installed in a first facility and information corresponding to a second equipment installed in a second facility other than the first facility, comprising:
a step of storing usage environment information for the first equipment and usage environment information for the second equipment;
a step of extracting common information, which is commonly included in the usage environment information corresponding to the first equipment and the second equipment, from the usage environment information; and
a step of calculating a second index value which is obtained by normalizing one piece of numerical data corresponding to the first equipment using the common information corresponding to the first equipment and a third index value which is obtained by normalizing one piece of numerical data corresponding to the second equipment using the common information corresponding to the second equipment.
